(19) United States
(12) Patent Application Publication
(10) Pub. No.: US 2007/0119810 A1
(43) Pub. Date: May 31, 2007

(54) Breast Feeding Reminder Method and Device

(76) Inventor: Susan Boles, Carlsbed, CA (US)

Correspondence Address: MANUEL F. DE LA CERRA, 6885 CATAMARAN DRIVE, CARLSBAD, CA, 92011, US

(21) Appl. No.: 11/554,007

(22) Filed: Oct. 28, 2006

Related U.S. Application Data
(60) Provisional application No. 60/733,081, filed on Nov. 3, 2005.

(51) Int. Cl. A61J 1/00

(52) U.S. Cl. 215/365

(57) ABSTRACT

A novel device and method for determining which breast is appropriate for feeding are disclosed. The reminder device comprises a short strip of material with a fastener on either end and such that the reminder device may be removably attached to the mother's bra strap. The mother attaches the reminder device to the bra strap for the breast that is appropriate for the next feeding. When the mother concludes that feeding, she can move the reminder device and removably attached it to the other bra strap. Using the reminder device, the mother is able to determine from which breast it is appropriate to start the next feeding.

### 1 CLAIM OF PRIORITY

The present patent application claims priority to U.S. provisional patent application 60/733,081 filed on Nov. 3, 2005 by inventor Susan Boles. The content of the provisional patent application is incorporated herein by reference.

### 2 FIELD OF THE INVENTION

The present invention relates to breast feeding.

### 3 BACKGROUND OF THE INVENTION

Mothers usually use one of two techniques when breastfeeding their child. In one technique, the mother may use one breast for each feeding and she must alternate breasts for the next feeding. In the second technique, the mother alternates breasts within a single feeding. Specifically, the mother starts breastfeeding on one breast and when the child finishes with that breast, the mother will offer the other breast for feeding. On the next feeding, the mother should begin feeding from the breast she last used on the previous feeding. The purpose for this is that the child has a much better chance of receiving the nutritious hind milk and the breasts are less likely to become over-engorged. By way of background, the breast produces two types of milk, the fore milk and the hind milk. The fore milk is very watery and does not contain the same nutritional value of the hind milk. As a child feeds, she first receives the fore milk and then the hind milk. Because a child usually feeds longer on the first breast, often draining the breast completely, the mother will alternate to the other breast to provide additional milk. However, the child may only receive fore milk from the second breast because she may not feed as long on that breast. By starting the next feeding with the breast last used on the previous feeding, the child will receive more hind milk and will likely drain the breast completely before alternating. This prevents the breasts from becoming over-engorged, which can be extremely painful and uncomfortable.

In either technique, the mother must track which breast was used in the last feeding. The rigors of motherhood, however, often makes it difficult to track which breast was used for the previous feeding, and thus which breast should be used for the current feeding.

Some methods are available that may assist a mother with the proper breastfeeding order. For example, to assist with the first breastfeeding technique described above, the mother may designate a certain breast for feeding at a particular time. If the baby's feeding schedule is four times a day—say at 8:00 AM, 12:00 PM, 4:00 PM and 8:00 pm—the mother may start with the left breast and alternate for each feeding. The mother therefore knows that every 8:00 AM feeding is from the left breast, while every 12:00 pm feeding is from the right breast. While this method is effective, it only works if there is an even number of feedings. Also, should the baby require an extra feeding it will throw the designated time feedings off. Therefore, this method sufferers from several shortcomings.

Another method that mothers use in either of the two techniques described above is keeping a breastfeeding diary. For each feeding the mother notes which breast was used, or the order of the breasts used. The mother consults the diary to determine which breast is appropriate for the current feeding. While this method is extremely accurate, it requires that the mother be very diligent in detailing her breast-feeding. Given the rigors of motherhood, this may be too much to ask.

Therefore, a need exists for a simple device and method to accurately recall which breast is appropriate for feeding.

### 4 SUMMARY OF THE INVENTION

The present invention provides a breastfeeding reminder device and method for determining which breast is appropriate for feeding. Specifically, the reminder device comprises a short strip of material with a fastener such that the reminder device may be fastened to the mother's bra strap. The fastener may be comprised of, but not limited to, a set of magnets, a magnet a piece of metal, Velcro, a button, a clasp or a hook. The mother may fasten the reminder device to the bra strap for the breast that is appropriate for the next feeding. When the mother concludes that feeding, she can move the reminder device and fasten it to the other bra strap. The mother therefore knows that the side with the reminder device is appropriate for starting the next feeding. The reminder device may also be fastened to other articles of clothing to indicate the proper order for breast feeding.

In another embodiment, the reminder device placed on the bra strap on the side that is not appropriate for starting the next feeding. In this case, the mother would feed from the breast for the side that does not have the reminder device. After feeding her child on that side, she would move the strap and fasten it to the side that was just used for feeding.

### 5 BRIEF DESCRIPTION OF THE DRAWINGS

FIG. 1 illustrates the reminder device in the open position.

FIG. 2 illustrates the reminder device in the open position, also illustrating the pocket for the fastener.

FIG. 3 is a side view of the reminder device.

FIG. 4 illustrates the reminder device in the closed position.

FIG. 5 shows the sewing pattern for manufacturing an embodiment of the reminder device.

FIG. 5 demonstrates the positioning of the reminder device on a mother's bra strap.

### 6 DETAILED DESCRIPTION OF THE INVENTION

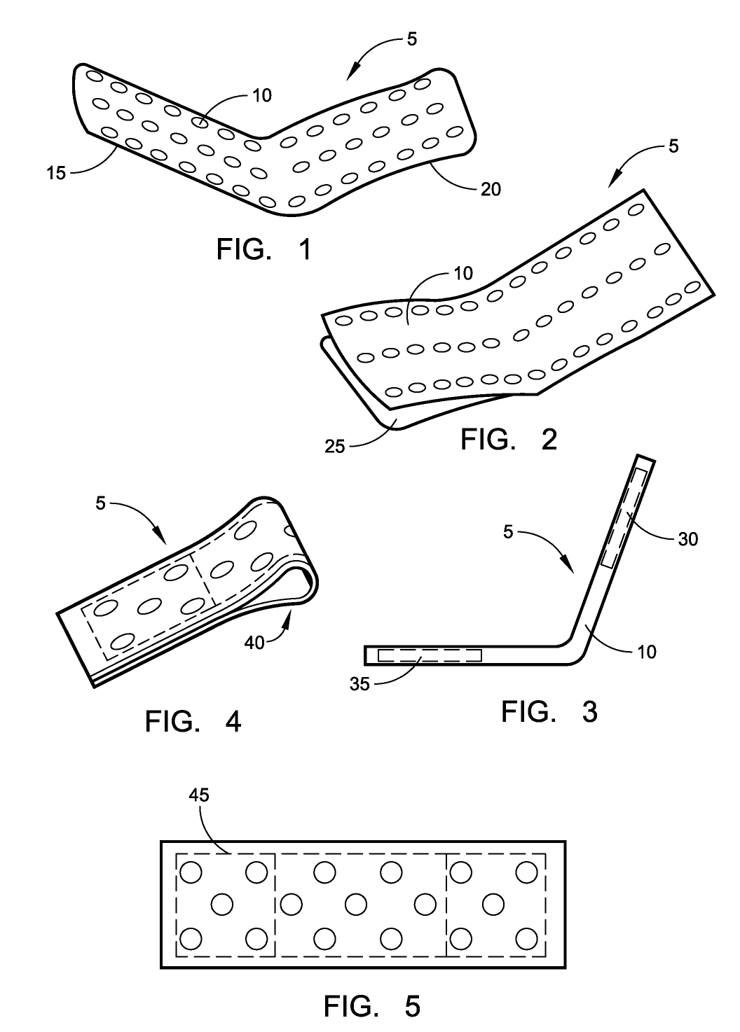

What is described below is a novel device and method for determining which breast is appropriate for feeding. FIG. 1 illustrates an embodiment of the reminder device (5). It is comprised of a piece of material (10) with a fastener-pair fixed at opposite ends (locations 15 and 20) of the material (10). FIG. 2 illustrates the reminder device (5) comprised of the material (10) where the fastener-pair is fixed to the material by means of a pocket (25). In one embodiment, both ends of the reminder device (5) have a pocket so as to receive the both portions of the fastener-pair. This is shown in FIG. 3, which is a side view of the reminder device (5) shown with two pockets (30 and 35). Preferably, the fastener-pair is comprised of two magnets that are designed to mate with each other. In FIGS. 1 to 3 the reminder device (5) is shown in the open position. Because the material (10) is flexible, as shown in FIG. 3, the fastener-pair may be brought in close proximity to each other, causing them to mate. Here, because the fastener-pair is a set of magnets, the mating is by magnetic attraction.

FIG. 4 illustrates the reminder device (5) is the closed position—i.e., the fastener-pair are mated to each other, forming a closed loop (40). The loop (40) may be used to removably attach the reminder device to a bra strap or other article of clothing. While the above embodiment illustrates the material (10) as flexible member adapted to fold upon itself, other configurations may exists. For example, the material may include a hinge that folds to allow the fastener-pair to mate. Also, the material may be rigid, semi-rigid or flexible.

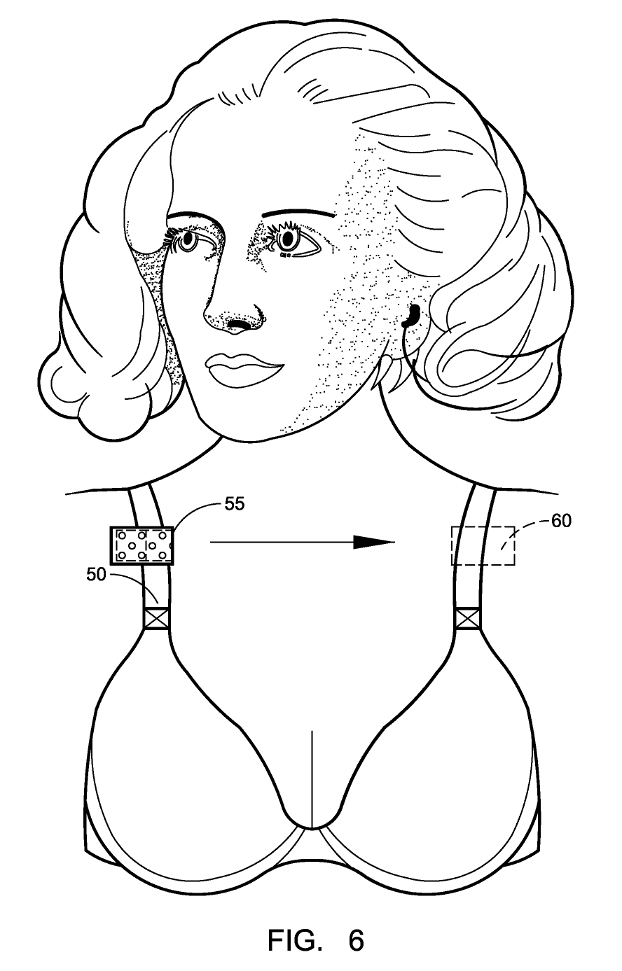

The above embodiment of the reminder device may be constructed as follows. A fabric ribbon that is ⅝ inches wide and 5 inches long comprises the piece of material. The ribbon is folded in half and the fastener-pair (in this case a set of magnets, more specifically a pair of rare earth neodymium magnetic discs) is sewn into pockets on either end of the ribbon. Often ribbons have aesthetic patterns on only one side. By folding the ribbon, the one-sided pattern can be completely exposed. Folding may also be used to form pockets into which the fastener-pair may be introduced. FIG. 5 illustrates the sewing pattern (dashed line 45) that may be used to form these pockets. Of course it would be apparent to those skilled in the art that the reminder devices may be constructed in various dimensions and configurations, and should not be limited to the examples/embodiments disclosed herein.

Now that the reminder device has been described, the method for using the reminder device will be presented. In FIG. 6, a mother would open the reminder device (the position shown in FIGS. 1 to 3) and place the reminder device on her bra strap (50) and close the reminder device by mating the fastener pair (the position shown in FIG. 4). By closing the reminder device, it becomes removably attached to the bra strap at position 55 and can easily be removed by unfastening the fastener pair. The mother would initially place the reminder device on the bra strap that supports the breast that is appropriate for the next feeding (in this case at position 55). In this way, when the mother is preparing for the next feeding, she knows that she should start feeding from the breast on the same side as the reminder device. After identifying the proper breast for feeding, the mother detaches the reminder device and reattaches it to the opposite bra strap (at position 60); thus indicating that the other breast is appropriate to start the next feeding. It should also be understood that the reminder device may be placed on other articles of clothing, and is not limited to a bra strap. For example, placing the reminder device on other types of undergarments, on a lapel or sleeve would also serve to indicate which breast should be use for the next feeding.

In the method just described, the reminder device was attached on the same side as the breast that is appropriate for feeding such that a mother preparing to feed her child would start feeding from the breast on the same side as the reminder device. It is also possible, however, to have the reminder device indicate the side that is not appropriate for the next feeding—which necessarily indicates the side that is appropriate for the next feeding. Specifically, using this method a mother who is preparing to feed her child would start feeding from the breast that is on the opposite side as the reminder device. After identifying the proper breast for feeding, the mother detaches the reminder device and reattaches it to the opposite bra strap.

It is important to note that the reminder device and the methods describe above may be used by mothers subscribing to either of the two breastfeeding techniques. By alternating the placement of the reminder device from one feeding to the next, the mother can accurately track the appropriate breast from which to start the next feeding.

The reminder device has thus far been described as having a fastener-pair fixed to opposite ends of the reminder device. However, it is also possible to simply have a singular fastener fixed to one end of the reminder device. For example, the reminder device may be comprised of the material with a magnet on one end. The magnet may fasten itself to the bra strap by making a magnetic connection to a metal clasp on the bra itself. Alternatively, the reminder device may have as a fastener one half of a Velcro pair. As an aside, Velcro is generally manufactured with two halves, and when these halves are brought together they fastened to each other. The bra strap may comprise the other half of the Velcro pair. Thus, the reminder device may be fastened to the bra strap using the pair of Velcro halves—i.e. one on the reminder device and one on the bra strap.

While the embodiments described above have made specific reference to a set of magnets, it would be apparent to those skilled in the art that the fastener may be comprised of several different types. For example, a magnet and a piece of metal would allow the reminder device to fasten. The fastener may also be comprised of Velcro, a button, a clasp, or a hook. Also, the fastener need not be sewn into a pocket, but may be fixed to the material by any available means including, but not limited to, chemical adhesion and riveting. Finally, although the fastener is described above as being placed on the opposite ends of the material, the fastener may be placed on any appropriate portion that allows it to be removably attached to the article of clothing used to indicate the proper breast feeding order.

Having described the system in detail and by reference to several preferred embodiments thereof, it will be apparent that modifications and variations are possible without departing from the scope of the invention defined in the following claims. Moreover, the applicant expressly does not intend that the following claims “and the embodiments in the specification to be strictly coextensive.” Phillips v. AHW Corp., 415 F.3d 1303, 1323 (Fed. Cir. 2005) (en banc).

1. A method for determining from which breast it is appropriate to start a feeding, said method comprising:
(a) providing a reminder device, wherein the reminder device comprises a piece of material and a fastener fixed to the material, wherein the reminder device is adapted to be removably attached to clothing;
(b) attaching the reminder device to the clothing to indicate from which breast it is appropriate to start feeding;
(c) feeding from the breast indicated in step (b);
(d) detaching the reminder device; and
(e) attaching the reminder device to the clothing to indicate from which breast it is appropriate to start the next feeding.

2. The method of claim 1, wherein the fastener further comprises a fastener pair, wherein each part of the pair is fixed to opposite ends of the material, and wherein in step (b) the two parts mate with each other to removably attach the reminder device to the clothing.

3. The method of claim 1, wherein in step (b) the clothing contains a second fastener and the reminder device attaches using the second fastener.

4. The method of claim 1, wherein the fastener is selected from a group consisting of: a pair of magnets, a magnet and a piece of metal, a button, a clasp, Velcro, a hook, and combinations thereof.

5. The method of claim 1, wherein the clothing is comprised of a bra strap.

6. The method of claim 1, wherein the clothing is comprised of a lapel.

7. The method of claim 1, wherein the clothing is comprised of an undergarment.

8. The method of claim 1, wherein step (b) further comprises attaching the reminder device on the same side as the breast from which it is appropriate to start a feeding.

9. The method of claim 1, wherein step (b) further comprises attaching the reminder device on the opposite side from the breast from which it is appropriate to start a feeding.

10. The method of claim 1, further comprising that after step (c) feeding from the opposite breast from that used in step (c).

11. A breast feeding reminder device for determining from which breast it is appropriate to start a feeding, said reminder device comprising:
a piece of material;
a fastener pair comprised of two parts adapted to mate with each other, wherein each part is placed on opposite ends of the material; and
wherein the reminder device is adapted to be removably attached to clothing when the two parts mate with each other.

12. The method of claim 11, wherein the fastener pair is selected from a group consisting of: a pair of magnets, a magnet and a piece of metal, a button, a clasp, Velcro, and combinations thereof.

13. The method of claim 11, wherein the clothing is comprised of a bra strap.

14. The method of claim 11, wherein the clothing is comprised of a lapel.

15. The method of claim 11, wherein the clothing is comprised of an undergarment.

16. A breast feeding reminder device for determining which breast is appropriate for feeding, said reminder device comprising:
a piece of material;
a pair of magnets adapted to mate with each other, wherein each magnet is fixed to opposite ends of the material; and
wherein the reminder device is adapted to be removably attached to a bra strap when the two magnets mate with each other.

17. The reminder device of claim 16, wherein the pair of magnets is comprised of a pair of rare earth, niodymium magnetic discs.

18. The reminder device of claim 16, wherein the material further comprises at least one pocket and one of the pair of magnets is placed in the pocket.

19. The reminder device of claim 16, wherein the material further comprises a ribbon.
